(19) United States
(12) Patent Application Publication
(10) Pub. No.: US 2018/0097413 A1
(43) Pub. Date: Apr. 5, 2018

(54) MOTOR AND ROTOR THEREOF

(71) Applicant: Johnson Electric S.A., Murten (CH)

(72) Inventors: Ning SUN, Shenzhen (CN); Rui Feng QIN, Hong Kong (CN); Xiao Hong ZHOU, Shenzhen (CN); Xing LIU, Shenzhen (CN)

(21) Appl. No.: 15/720,279

(22) Filed: Sep. 29, 2017

(30) Foreign Application Priority Data
Sep. 30, 2016 (CN) 201610873290.X

(51) Int. Cl. H02K 1/28; H02K 1/27; H02K 5/04; H02K 5/02

(52) U.S. Cl. CPC H02K 1/28; H02K 5/02; H02K 5/04; H02K 1/2786

(57) ABSTRACT

A rotor includes a rotor core and a plurality of magnets. The magnets are fixed on an outer circumferential surface of the rotor core. The rotor further includes at least one protective tube. The protective tube includes a cover portion. An inner circumference of the cover portion is greater than a length of an envelope line formed by outer circumferential surfaces of the magnets and common tangents of the outer circumferential surfaces of adjacent magnets, and is less than a circumference of a circumscribed circle of the magnets. The cover portion covers the magnets in a circumferential direction, thereby guaranteeing the fixing strength of the magnets while also preventing the magnets from breaking.

### CROSS REFERENCE TO RELATED APPLICATIONS

This non-provisional patent application claims priority under 35 U.S.C. § 119(a) from Patent Application No. 201610873290.X filed in The People's Republic of China on Sep. 30, 2016.

### FIELD OF THE INVENTION

The present invention relates to a rotor and a motor including the rotor, and in particular to a motor suitable for an electric power steering system and a rotor of the motor.

### BACKGROUND OF THE INVENTION

Currently, a plurality of magnets is arranged on an outer circumferential surface of a rotor core. A non-magnetic protective tube is provided to cover the magnets in order to prevent the plurality of magnets from flying away from the rotor core when the rotor rotates. Therefore, how to arrange the protective tube to guarantee the fixing strength of the magnets to prevent movement of the magnets without breaking the magnets due to overlarge stress has become an issue to be solved in the industry.

### SUMMARY OF THE INVENTION

Thus there is a desire for a new rotor and motor.

In one aspect, a rotor is provided. The rotor includes a rotor core and a plurality of magnets. The plurality of magnets is fixed on an outer circumferential surface of the rotor core. The rotor further includes at least one protective tube. Each protective tube includes a cover portion. An inner circumference of the cover portion is greater than a length of an envelope line formed by outer circumferential surfaces of the magnets and common tangents of the outer circumferential surfaces of adjacent magnets, and is less than a circumference of a circumscribed circle of the magnets. The cover portion covers the plurality of magnets in a circumferential direction.

Preferably, each protective tube further includes a tapered portion. The tapered portion expands radially and outwardly from an end of the cover portion to form a tapered shape. An inner circumference of an opening of the tapered portion is greater than or equal to the circumference of the circumscribed circle of the magnets.

Preferably, the number of the at least one protective tube is two, and the tapered portions of the two protective tubes face toward each other and are fixed to each other.

Preferably, a total axial length of the two protective tubes is greater than or equal to a total axial length of the rotor core.

Preferably, one end of the cover portion defines an opening, and a flange radially and inwardly protrudes from a peripheral edge of the cover portion so that the flange covers a portion of the opening.

Preferably, the flange is fixedly connected to the rotor core.

Preferably, the cover portion comprises a plurality of first sections in contact with substantial peaks of the magnets and a plurality of second sections which is not in contact with substantial peaks of the magnets, and a thickness of the first section is less than a thickness of the second section.

Preferably, a plurality of protrusions is formed on the outer circumferential surface of the rotor core, the protrusions extend radially and outwardly from the outer circumferential surface of the rotor core, the protrusions are spaced apart from each other, and a receiving space is formed between each two adjacent protrusions for receiving one of the magnets.

Preferably, a top portion of each of the magnets radially protrudes beyond the two neighboring protrusions.

Preferably, the outer circumferential surface of the rotor core defines a plurality of receiving grooves, the receiving grooves are formed by recessing the outer circumferential surface of the rotor core, and each receiving groove is configured to receive one of the magnets.

Preferably, the protective tube is made of a non-magnetic conductive material.

In another aspect, a motor is provided. The motor includes a stator and any one of the above-mentioned rotors. The rotor is rotatably received in the stator.

In still another aspect, a motor is provided. The motor includes a stator and any one of the above-mentioned rotors. The stator is positioned at a radial outer side of the rotor.

The inner circumference of the cover portion is greater than the length of the envelope line formed by the outer circumferential surfaces of the magnets and common tangents of the outer circumferential surfaces of adjacent magnets, and is less than the circumference of the circumscribed circle of the magnets, thereby guaranteeing the fixing strength of the magnets while also preventing the magnets from breaking.

### BRIEF DESCRIPTION OF THE DRAWINGS

FIG. 1 is a perspective view of a rotor after assembly in accordance with an embodiment of the present invention;

FIG. 2 is a perspective view of a rotor before assembly in accordance with an embodiment of the present invention;

FIG. 3 is a perspective view of a silicon steel plate of a rotor core of the rotor of FIG. 2;

FIG. 4 is a cross-sectional view of the rotor of FIG. 1, taken along line IV-IV thereof;

FIG. 5 is a perspective view of a protective tube of the rotor of FIG. 2;

FIG. 6 is a vertical sectional view of the protective tube of FIG. 5;

FIG. 7 is a partial enlarged view of the part VII of the rotor in FIG. 4; and

FIG. 8 is a perspective view of a motor in accordance with an embodiment of the present invention.

### DETAILED DESCRIPTION OF THE PREFERRED EMBODIMENTS

Embodiments of the present invention will be described in greater detail with reference to the drawings. It should be noted that the figures are illustrative rather than limiting. The figures are not drawn to scale, do not illustrate every aspect of the described embodiments, and do not limit the scope of the present disclosure. Unless otherwise specified, all technical and scientific terms used in this disclosure have the ordinary meaning as commonly understood by people skilled in the art.

When an element or a layer is referred to as “being connected to” another element or layer, the element or the layer can be located directly on another element or layer so as to be connected to another element or layer, or there may be an intermediate element and/or layer. In contrast, when an element is referred to as “being directly connected” to another element or layer, there is no intermediate element or layer.

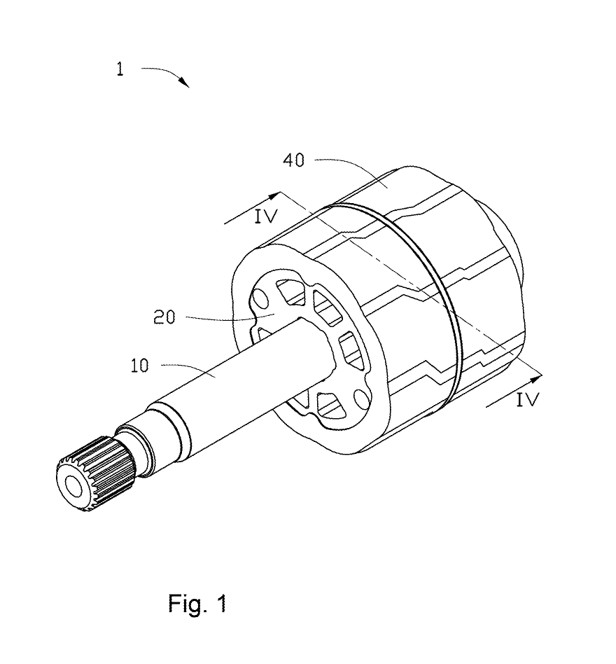

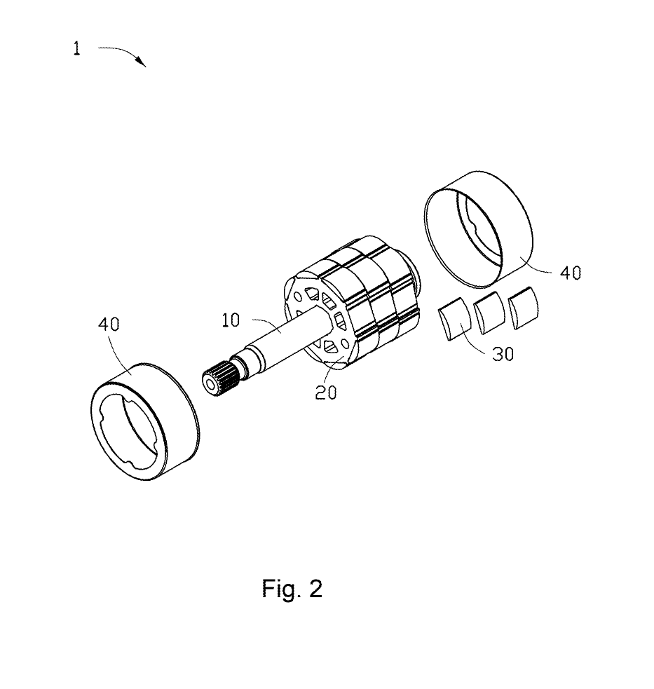

FIGS. 1 and 2 are schematic views of a rotor in accordance with an embodiment of the present invention. The rotor 1 includes a rotary shaft 10, a rotor core 20, a plurality of magnets 30, and a protective tube 40. The rotor core 20 is fixed to the rotary shaft 10. The magnets 30 are arranged on an outer circumferential surface of the rotor core 20 and are spaced apart from each other. The protective tube 40 covers the plurality of magnets 30. The protective tube 40 is configured to protect the magnets 30 and prevent the magnets 30 from flying away the outer circumferential surface of the rotor core 20. In the present embodiment, the protective tube 40 is substantially cylindrical before assembly (shown in FIG. 2), and is deformed into a polygonal shape after assembly (shown in FIG. 1). The rotor of the present embodiment will be described in detail below.

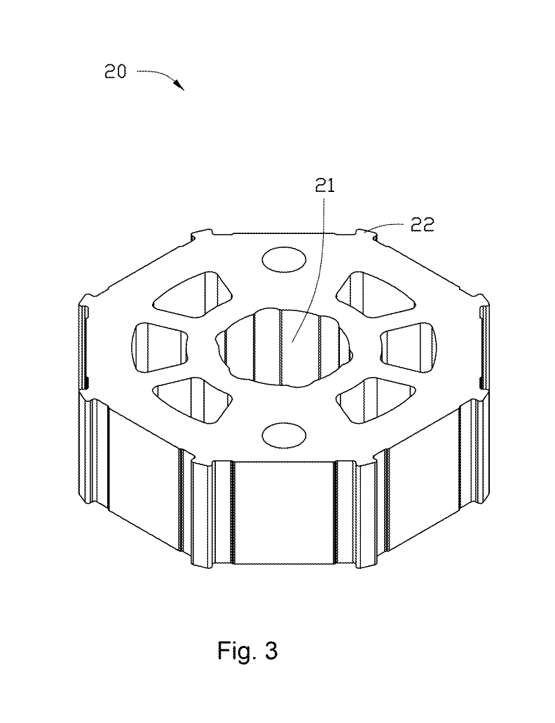

FIG. 3 is a schematic view of a silicon steel plate of the rotor core 20 of the present embodiment. The rotor core 20 is formed by stacking a plurality of silicon steel plates with each other. In this embodiment, the amount of the silicon steel plates is three. In other embodiments, the amount of the silicon steel plates is two or more. The cross-section of the rotor core 20 is substantially a polygon in shape. A shaft hole 21 is defined in a substantially central portion of the rotor core 20. The shaft hole 21 is configured for receiving the rotary shaft 10. A plurality of positioning structures 22 is formed on the outer circumferential surface of the rotor core 20. The positioning structures 22 are configured to prevent the magnets 30 from moving in a circumferential direction of the rotor core 20, so as to position the magnets 30 and prevent movement of the magnets 30. Each of the positioning structures 22 is a protrusion. Each protrusion extends radially and outwardly from the outer circumferential surface of the rotor core 20. The protrusions are spaced apart from each other. In this embodiment, the protrusions are spaced apart from each other by a predetermined distance. A receiving space is formed between every two adjacent protrusions for receiving a magnet 30. In this embodiment, the amount of the protrusions is eight. In other embodiments, the amount of the protrusions is two, four, six, eight, twelve, or another suitable number. Alternatively, each positioning structure 22 is a receiving groove. The receiving groove is formed by recessing the outer circumferential surface of the rotor core 20. A protrusion is formed between two adjacent receiving grooves. In this embodiment, the amount of the receiving grooves is eight, and the amount of the protrusions is eight. In other embodiments, the amount of the receiving grooves is two, four, six, eight, twelve, or another suitable number, and the amount of the protrusions is two, four, six, eight, twelve, or another corresponding number. Each receiving groove is configured to receive one magnet 30.

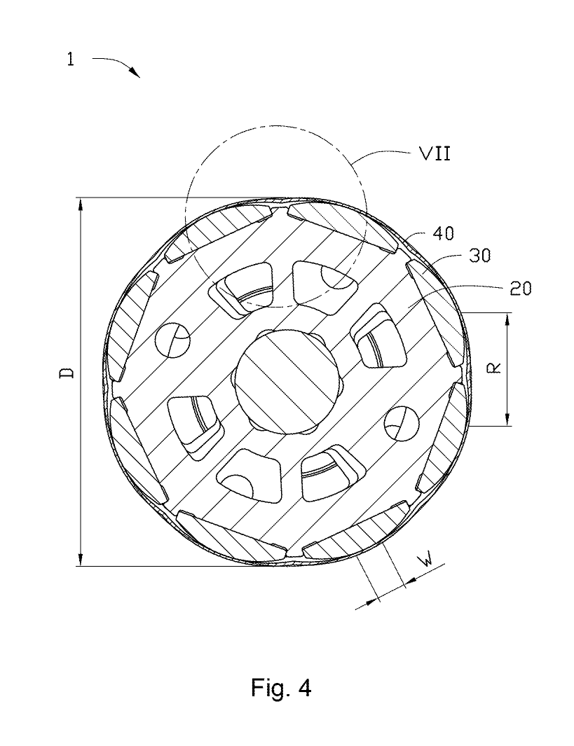

FIG. 4 is a cross-sectional view of the rotor 1. In this embodiment, the magnets 30 are permanent magnets, such as neodymium magnets or ferrite magnets. The plurality of magnets 30 forms magnetic poles of the rotor 1. Each magnet 30 has a substantially circular arc-shaped outer surface. Each magnet 30 is arranged between two adjacent protrusions or is received in the receiving groove, and a top portion of the magnet 30 protrudes beyond the neighboring protrusions in the radial direction. A width of each magnet 30 is substantially the same as the predetermined distance between the adjacent protrusions. In this embodiment, the magnets 30 are adhered to the outer circumferential surface of the rotor core 20. Specifically, the magnets 30 are adhered to the outer circumferential surface of the rotor core 20 with adhesive, so that the magnets 30 are fixed to the outer circumferential surface of the rotor core 20. Because the adjacent protrusions are spaced apart from each other by the predetermined distance, the magnets 30 are arranged at equal intervals in the circumferential direction of the rotor core 20, and the rotor 1 generates uniform magnetic flux along a circumference of the rotor 1, so that a rotating force generated by the magnetic flux does not fluctuate. In this embodiment, the amount of the magnets 30 is eight, and the motor is an 8-pole motor. In other embodiments, the amount of the magnets 30 is two, four, six, ten, twelve, or another suitable number and, accordingly, the motor is a 2-pole motor, a 4-pole motor, a 6-pole motor, a 10-pole motor, a 12-pole motor, or a motor with another suitable number of poles. In this embodiment, a diameter of a circumscribed circle of the magnets 30 is represented by D, and the circumference of the circumscribed circle of the magnets 30 is represented by π*D.

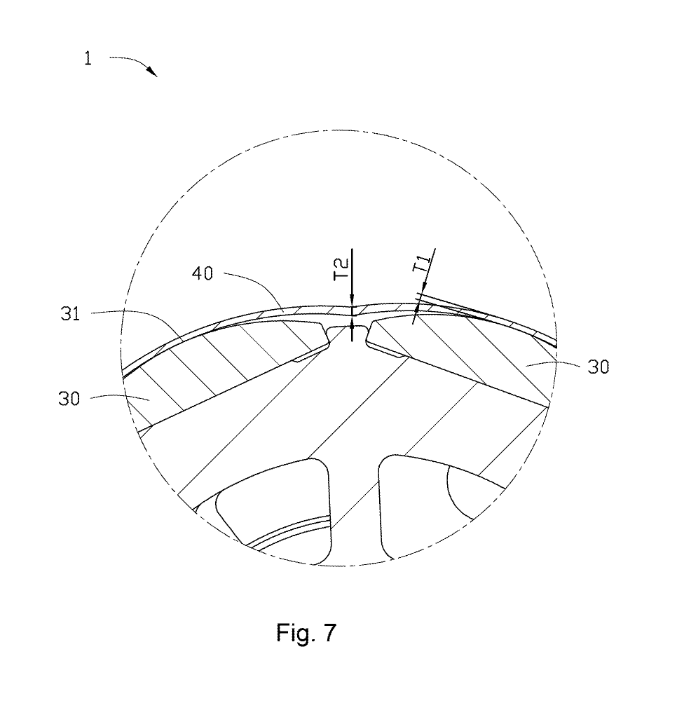

An envelope line formed by the outer circumferential surfaces of the magnets 30 and common tangents of the outer circumferential surfaces of the adjacent magnets 30 has a length L. When the magnets 30 are covered by the protective tube 40, the magnets 30 contact the protective tube 40 to form contact areas 31 (shown in FIG. 7). An outline length of the outer surface of each contact area 31 (arc segment) is represented by W. A distance between each two adjacent contact areas 31 (line segment)is represented by R. The length L of the envelope line can be calculated using the following formula:

L=P*(W+R)

where, L represents the length of the envelope line, P represents the number of the magnetic poles of the motor, W represents the outline length of the outer surface of each contact area 31, and R represents the distance between each two adjacent contact areas 31.

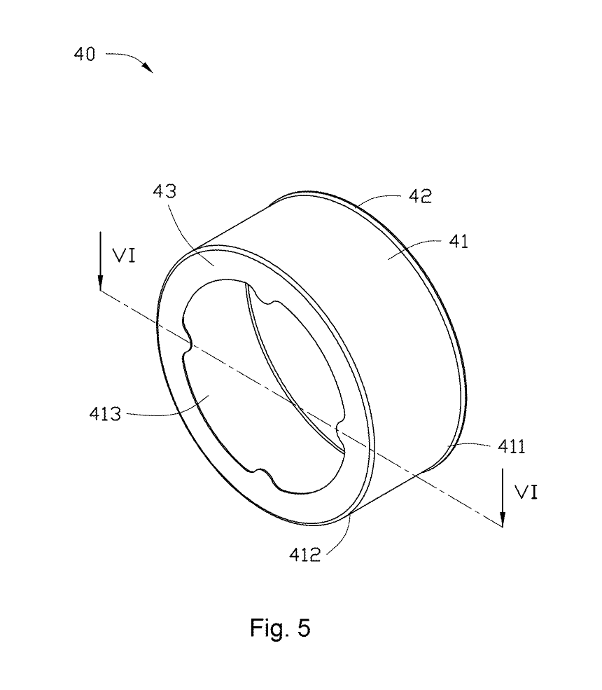

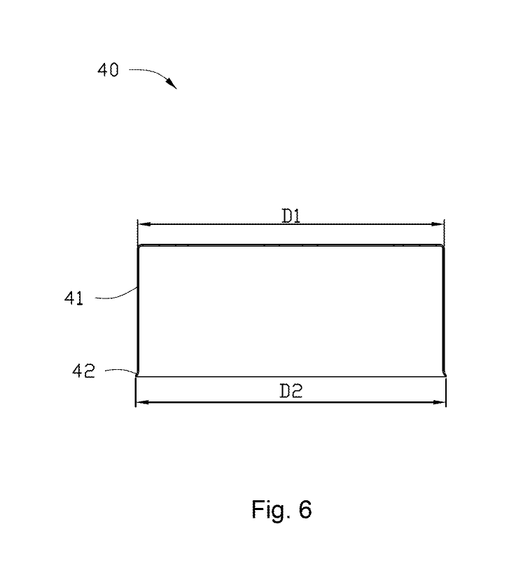

Referring to FIG. 5 and FIG. 6, in this embodiment, there are two protective tubes 40. A total axial length of the two protective tubes 40 is greater than or equal to the total axial length of the rotor core 20. Obviously, in other embodiments, there can be only one protective tube 40, and the length of the protective tube 40 is greater than or equal to the total length of the rotor core 20. Before the protective tubes 40 are attached to the outer circumferential surface of the magnets 30, the protective tube 40 is substantially cylindrical in shape, and the thickness of the protective tube 40 is represented by T. In this embodiment, the protective tube 40 is made of stainless steel, aluminum, or the like. The two protective tubes 40 are arranged end-to-end to cover the magnets 30. Referring to FIG. 2, the two protective tubes 40 move toward each other until abutting against each other to cover the magnets 30. Therefore, it is more convenient to sleeve two protective tubes 40 on the outer circumferential surfaces of the magnets 30 than to sleeve a single protective tube 40 on the outer circumferential surfaces of the magnets 30. The protective tube 40 is made of a non-magnetic conductive material to avoid magnetic flux leakage.

Each protective tube 40 includes a cover portion 41, a tapered portion 42, and a flange 43. The cover portion 41 is substantially cylindrical before assembly. The cover portion 41 includes a first end 411 and a second end 412 opposite to the first end 411. The cover portion 41 defines an opening 413 at the second end 412. The cover portion 41 is configured to cover the magnets 30 in the circumferential direction. An inner diameter of the cover portion 41 is represented by D1, and an inner circumference of the cover portion 41 is represented by π*D1. The tapered portion 42 expands radially and outwardly from the first end 411 to form a tapered shape. The tapered portion 42 defines an inlet allowing the protective tube 40 to sleeve on the outer surfaces of the magnets 30. An inner diameter of an opening of the tapered portion 42 is represented by D2, and an inner circumference of the opening of the tapered portion 42 is represented by π*D2.

The relationship between the inner circumference π*D2 of the opening of the tapered portion 42, the circumference of the circumscribed circle π*D of the magnets 30, the inner circumference π*D1 of the cover portion 41, and the length L of the envelope line is: π*D2 ≧π*D>π*D1>L. Since the inner circumference π*D2 of the opening of the tapered portion 42 is greater than or equal to the circumference of the circumscribed circle π*D of the magnets 30, during assembly, the two tapered portions 42 can be used as the inlets such that the two protective tubes 40 can easily move toward each other to cover the outer surfaces of the magnets 30. In this embodiment, inner circumferential surfaces of the protective tubes 40 or the outer circumferential surfaces of the magnets 30 are coated with lubricants (not shown) such as oil, paraffin or wax, thereby reducing the friction between the inner circumferential surfaces of the protective tubes 40 and the outer circumferential surfaces of the magnets 30. Therefore, it is easier to sleeve the two protective tubes 40 on the outer circumferential surfaces of the magnets 30. After assembly, the tapered portions of the two protective tubes 40 face toward each other and are fixed to each other. In this embodiment, after assembly, the tapered portions of the two protective tubes 40 are fixed to each other by welding.

In addition, since the inner circumference π*D1 of the cover portion 41 is less than the circumference of the circumscribed circle π*D of the magnets 30, during assembly, a section of the cover portion 41 in contact with a substantial peak of each magnet 30 is deformed to expand under the engagement of the substantial peak, so that the thickness of the section of the cover portion 41 in contact with the substantial peak of the magnet 30 decreases to T1. The thickness of sections of the cover portion 41 not in contact with the substantial peaks of the magnets 30, that is, the other sections of the cover portion represented by T2 are thicker than the section of the cover portion 41 in contact with the substantial peak of each magnet 30 (shown in FIG. 7). As a result, the cover portion 41 is deformed into a polygonal shape from the cylindrical shape. Thus, the cover portion 41 can apply a radial force to the magnets 30 under a restoring force of the cover portion 41, so that the magnets 30 are restricted on the rotor core 20. Since the thickness of the other sections of the cover portion 41 is greater than the section of the cover portion 41 in contact with the substantial peak of each magnet 30, the protective tube 40 can restrict the magnets 30 in the circumferential direction. Meanwhile, since the inner circumference π*D1 of the cover portion 41 is less than the circumference of the circumscribed circle π*D of the magnets 30, the maximum inner diameter of the cover portion 41 is equal to the circumscribed circle diameter of the magnets 30 when the cover portion 41 is deformed, and a gap between a stator and the rotor 1 is constant, which does not bring obstacles to the rotation of the rotor 1.

Meanwhile, the inner circumference π*D1 of the cover portion 41 is greater than the length L of the envelope line, which can prevent the magnets 30 from breaking due to overlarge pressure applied by the cover portion 41.

The peak of the magnet 30 of the present invention means an outermost portion of the magnet 30 in the radial direction of the rotor core 20, i.e. points on the outer surface of the magnet 30 which are farthest from an axis of the rotor core 20.

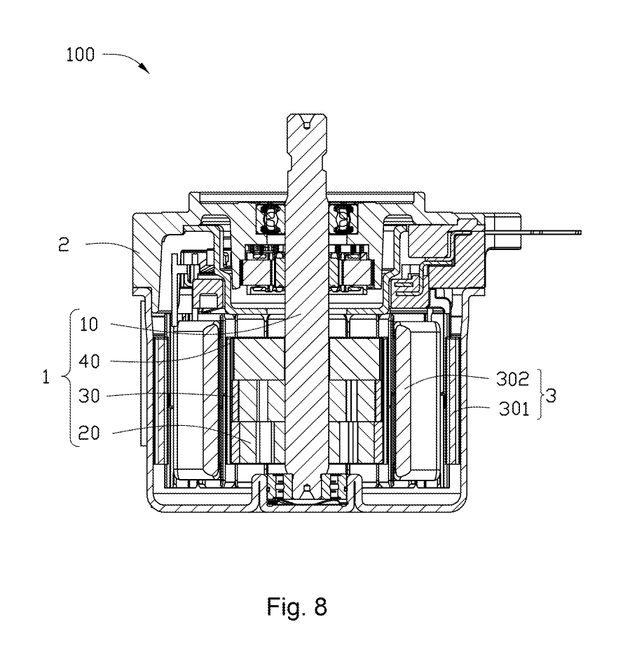

The flange 43 radially and inwardly protrudes from a peripheral edge of the cover portion 41, so that the flange 43 covers a portion of the opening 413. In this embodiment, the flange 43 is ring-shaped. In other embodiments, the flange is circular ring-shaped, arc-shaped, or of another shape. Since the total axial length of the two protective tubes 40 is greater than or equal to the total axial length of the rotor core 20, the flange 43 covers a portion of the rotor core 20 (shown in FIG. 1) when the protective tube 40 covers the outer circumferential surfaces of the magnets 30. In this embodiment, the flange 43 is welded to the rotor core 20, so that the flange 43 positions the magnets 30 in an axial direction. In this embodiment, the tapered portion 42, the cover portion 41, and the flange 43 are integrally formed. In other embodiments, the tapered portion 42, the cover portion 41, and the flange 43 are partially integrally formed or are individual elements. FIG. 8 is a sectional view of a motor 100. The motor 100 is suitable for an electric power steering system. The motor 100 includes a housing 2, a rotor 1, and a stator 3. The rotor 1 is rotatably disposed inside the housing 2. The rotor 1 includes the rotary shaft 10, the rotor core 20, the magnets 30, and the protective tube 40. The rotor core 20 is fixed to the rotary shaft 10. The magnets 30 are fixed to the outer circumferential surface of the rotor core 20. The protective tube 40 covers the magnets 30 to protect the magnets 30 and prevent the magnets 30 from flying away the outer circumferential surface of the rotor core 20 during rotation. The stator 3 is fixed inside the housing 2, and positioned at a radial outer side of the rotor 1, so that the rotor 1 is rotatably received in the stator 3. The stator 3 includes a stator core 301 and a plurality of coils 302 wound around the stator core 301. Upon energized, the plurality of coils 302 generates a magnetic field, and the magnets 30 interact with the magnetic field generated by the coils 302, so that the rotor 1 rotates in response to the magnetic field.

Thus, in the embodiments of the present invention, the magnets 30 are prevented from moving in the circumferential direction of the rotor core 20 through the positioning structures 22, thereby positioning the magnets 30. It is more convenient to sleeve the two protective tubes 40, which engage end-to-end, on the outer circumferential surfaces of the magnets 30 to cover the magnets than to sleeve the single protective tube 40 on the outer circumferential surfaces of the magnets 30, which facilitates the assembly of the protective tube 40. Since the inner circumference π*D2 of the opening of the tapered portion 42 is greater than or equal to the circumference of the circumscribed circle π*D of the magnets 30, during assembly, the two tapered portions 42 can be used as the inlets so that the two protective tubes 40 can easily move toward each other to sleeve on the outer circumferential surfaces of the magnets 30. Since the inner circumference π*D1 of the cover portion 41 is less than the circumference of the circumscribed circle π*D of the magnets 30, the cover portion 41 is deformed into a polygonal shape from a cylindrical shape and, as a result, the cover portion 41 applies a radial force to the magnets 30. In addition, since the thickness of sections of the cover portion 41 not in contact with the substantial peaks of the magnets 30 is thicker than the section of the cover portion 41 in contact with the substantial peak of each magnet 30, the protective tube 40 can restrict the magnets 30 in the circumferential direction. Meanwhile, since the inner circumference π*D1 of the cover portion 41 is less than the circumference of the circumscribed circle π*D of the magnets 30, the gap between the stator 3 and the rotor 1 is constant, which does not bring obstacles to the rotation of the rotor 1. Meanwhile, the inner circumference π*D1 of the cover portion 41 is greater than the length L of the envelope line, which can prevent the magnets 30 from breaking due to overlarge pressure applied by the cover portion 41.

Although the invention is described with reference to one or more embodiments, the above description of the embodiments is used only to enable people skilled in the art to practice or use the invention. It should be appreciated by those skilled in the art that various modifications are possible without departing from the spirit or scope of the present invention. The embodiments illustrated herein should not be interpreted as limits to the present invention, and the scope of the invention is to be determined by reference to the claims that follow.

1. A rotor comprising:
a rotor core;
a plurality of magnets fixed on an outer circumferential surface of the rotor core; and
at least one protective tube, each protective tube comprising a cover portion, an inner circumference of the cover portion being greater than a length of an envelope line formed by outer circumferential surfaces of the magnets and common tangents of the outer circumferential surfaces of adjacent magnets, and being less than a circumference of a circumscribed circle of the magnets, and the cover portion covering the plurality of magnets in a circumferential direction.

2. The rotor of claim 1, wherein each protective tube further comprises a tapered portion, the tapered portion expands radially and outwardly from an end of the cover portion to form a tapered shape, and an inner circumference of an opening of the tapered portion is greater than or equal to the circumference of the circumscribed circle of the magnets.

3. The rotor of claim 1, wherein the number of the at least one protective tube is two, and the tapered portions of the two protective tubes face toward each other and are fixed to each other.

4. The rotor of claim 3, wherein a total axial length of the two protective tubes is greater than or equal to a total axial length of the rotor core.

5. The rotor of claim 1, wherein one end of the cover portion defines an opening, and a flange radially and inwardly protrudes from a peripheral edge of the cover portion so that the flange covers a portion of the opening.

6. The rotor of claim 5, wherein the flange is fixedly connected to the rotor core.

7. The rotor of claim 1, wherein the cover portion comprises a plurality of first sections in contact with substantial peaks of the magnets and a plurality of second sections which is not in contact with substantial peaks of the magnets, and a thickness of the first section is less than a thickness of the second section.

8. The rotor of claim 1, wherein a plurality of protrusions is formed on the outer circumferential surface of the rotor core, the protrusions extend radially and outwardly from the outer circumferential surface of the rotor core, the protrusions are spaced apart from each other, and a receiving space is formed between each two adjacent protrusions for receiving one of the magnets.

9. The rotor of claim 8, wherein a top portion of each of the magnets radially protrudes beyond the two neighboring protrusions.

10. The rotor of claim 1, wherein the outer circumferential surface of the rotor core defines a plurality of receiving grooves, the receiving grooves are formed by recessing the outer circumferential surface of the rotor core, and each receiving groove is configured to receive one of the magnets.

11. The rotor of claim 1, wherein the protective tube is made of a non-magnetic conductive material.

12. The rotor of claim 1, wherein the at least one protective tube is substantially cylindrical before assembly, and is deformed into a polygonal shape after assembly.

13. A motor comprising:
a stator; and
a rotor rotatably received in the stator, the rotor comprising:
a rotor core;
a plurality of magnets fixed on an outer circumferential surface of the rotor core; and
at least one cylindrical protective tube, each protective tube comprising a cover portion, an inner circumference of the cover portion being greater than a length of an envelope line formed by outer circumferential surfaces of the magnets and common tangents of the outer circumferential surfaces of adjacent magnets, and being less than a circumference of a circumscribed circle of the magnets, and the cover portion covering the plurality of magnets in a circumferential direction.

14. The motor of claim 13, wherein each protective tube further comprises a tapered portion, the tapered portion expands radially and outwardly from an end of the cover portion to form a tapered shape, and an inner circumference of an opening of the tapered portion is greater than or equal to the circumference of the circumscribed circle of the magnets.

15. The motor of claim 13, wherein the number of the at least one protective tubes is two, and the tapered portions of the two protective tubes face toward each other and are fixed to each other.

16. The motor of claim 15, wherein a total axial length of the two protective tubes is greater than or equal to a total axial length of the rotor core.

17. The motor of claim 16, wherein one end of the cover portion defines an opening, and a flange radially and inwardly protrudes from a peripheral edge of the cover portion so that the flange covers a portion of the opening.

18. The motor of claim 17, wherein the flange is fixedly connected to the rotor core.

19. The motor of claim 18, wherein a thickness of sections of the cover portion in contact with outer circumferential surface of the magnets is less than a thickness of sections of the cover portion which is not in contact with the outer circumferential surface of the magnets.

20. The motor of claim 19, wherein a plurality of protrusions is formed on the outer circumferential surface of the rotor core, the protrusions extend radially and outwardly from the outer circumferential surface of the rotor core, the protrusions are spaced apart from each other, and a receiving space is formed between each two adjacent protrusions for receiving one of the magnets.
